(19) United States
(12) Patent Application Publication
(10) Pub. No.: US 2008/0209952 A1
(43) Pub. Date: Sep. 4, 2008

(54) Method of Making Fiber Optic Couplers with Precise Postioning of Fibers

(76) Inventor: Julien Tremblay, Blainville (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/090,496

(22) PCT Filed: Oct. 17, 2006
(86) PCT No.: PCT/CA06/01701

§ 371 Date: Apr. 17, 2008

(30) Foreign Application Priority Data
Oct. 19, 2005 (CA) 2523930

(51) Int. Cl. C03B 37/00

(52) U.S. Cl. 65/402

(57) ABSTRACT

The method uses capillary holes in a glass preform for precise positioning of the optical fibers in the manufacture of a coupler. The glass preform is preferably cylindrical and longitudinal capillary holes are made in it in a desired pattern. Optical fibers are inserted in the holes and the glass preform is heated and stretched in its middle section so that the fibers, from which coating has been removed, contact and are fused with the glass preform in this tapered section. Then the tapered section is cleaved to form a coupling end which is spliced with another fiber to form the coupler.

### FIELD OF THE INVENTION

The invention generally relates to optical fiber couplers. More particularly, it relates to manufacturing of couplers with multiple fibers, such as 1×N or N×1, wherein the fibers are precisely positioned in the coupling bundle N. The invention also includes the method for making such coupling bundle with precisely positioned fibers.

### BACKGROUND OF THE INVENTION

Various types of couplers that use bundles of fibers to be coupled, hold such fibers in the bundle either mechanically or by twisting them together, and the structure is fused and/or tapered in order to induce coupling between the fibers. For example, applicant's Canadian patent application No. 2,441,918 and its corresponding U.S. application published under No. 2005/0094952 A1, discloses a coupler arrangement where a bundle of a plurality of multimode fibers having a few mode fiber in the middle is fused and possibly tapered at its output end and then this output end is aligned and spliced with the input end of a large area core double clad fiber (LACDCF) to form the coupler. FIGS. 8A to 8L of said patent application show different arrangements of the fibers that can be used within such bundle.

In order to have good power distribution in the couplers resulting from such bundles, it is important to position the fibers precisely according to the desired arrangement so as to obtain a symmetrical disposition of the various fibers in the bundle. This is not always easy to achieve. For example, U.S. Pat. No. 4,983,195 provides for this purpose a preform including a glass tube having a longitudinal aperture formed of a plurality of similarly shaped side walls with inwardly projecting protrusions into which are inserted optical fibers, one into each corner region; then the mid region of the tube is collapsed onto the fibers and at least a portion of it is stretched to reduce the tube diameter, while the protrusions maintain the fibers in their relative positions. In another similar patent, namely U.S. Pat. No. 5,017,206 the coupler preform is made up of two concentric glass tubes having a gap between them, in which optical fibers can be equally spaced.

The above described arrangements have many disadvantages since they require preforms with rather complex internal configurations which are not easy to make and which are not easy to adapt to fibers of different sizes. Thus, there is a need for a simple and efficient method of making fiber optic couplers with precise positioning of fibers in the coupling bundle.

### OBJECTS AND SUMMARY OF THE INVENTION

It is an object of the present invention to provide a simple and efficient method of making couplers, such as 1×N or N×1, by providing a precise positioning of the fibers in the coupling bundle, and also to provide a method for making the coupling bundle.

Another object of the invention is to provide a method suitable for including various sizes of fibers in the coupling bundle.

Other objects and advantages of the invention will become apparent from the following description thereof.

In essence, in the method of the present invention for making a coupler, the coupling bundle with precisely positioned optical fibers is made using the following steps:
(a) providing a glass preform with a plurality of longitudinal capillary holes therein having dimensions slightly larger than those of the optical fibers to be inserted thereinto, said holes being formed in a predetermined configuration within said glass preform;
(b) inserting uncoated optical fibers into said holes;
(c) heating a section of the glass preform and stretching the same until the fibers in the holes contact the periphery of the holes and fuse with the preform in said section thereby forming a tapered structure with a desired precise positioning of the optical fibers therein; and
(d) forming a coupling end in the tapered structure.

The coupling end formed in (d) above may be formed, for example, by applying adhesive at the ends of the preform to solidify the structure, then placing it under tension and cleaving or polishing the tapered structure to form said coupling end.

Then this coupling end is spliced to an end of another fiber to form the coupler.

An alternative embodiment comprises:
(a) providing a glass preform with a plurality of longitudinal capillary holes therein having dimensions slightly larger than those of optical fibers to be inserted therein, said holes being positioned in a predetermined configuration within said glass preform;
(b) heating a section of the glass preform and stretching the same until the holes therein have reduced dimensions essentially corresponding to those of the optical fibers, without coating, to be inserted thereinto;
(c) inserting uncoated optical fibers into said holes until they penetrate into and substantially fill the section with the holes having the reduced dimensions;
(d) further heating the section to fuse the inserted fibers with the glass preform in said section; thereby forming a tapered structure with a desired precise positioning of the fibers therein; and
(e) forming a coupling end in the tapered structure.

The coupling end in (e) may be formed as already described above and thereafter it is spliced to an end of another fiber to form the coupler.

It should be noted that the glass preform may be obtained by using a plurality of glass tubes with holes of predetermined size, which are properly placed side-by-side and longitudinally fused together. The uncoated optical fibers may be inserted into said fused glass tubes either before or after the tapering of the structure. It is preferable to insert the fibers so that ends of the remaining coating are placed within the ends of the holes.

It should also be noted that capillary holes of various sizes can be machined with great precision in glass preforms. For example, U.S. Pat. No. 6,470,123 discloses a manner in which this is done in a large optical fiber array assembly. For the purposes of the present invention, the glass preforms are preferably cylindrical and typically may have a length of 100 mm and a diameter of 1.4 mm, although these dimensions are by no means limitative.

The method of the present invention is very flexible, in that it allows to make holes of various diameters in the same preform to accommodate various types of fibers. The size of the holes before the preform is heated and stretched should preferably be such as to permit insertion of coated fibers. The preform may be made of quartz, of fused silica, of doped fused silica and of other types of glass suitable for coupling. Moreover, the structure is not limited to a specific number of holes. It should also be noted that the geometry of the holes need not be circular and may take different forms or shapes, allowing to accommodate different shapes of fibers. Also, it may be used with any types of fibers or combinations thereof, such as pumping fibers, gain fibers, signal transmitting fibers, polarization maintaining fibers and so on.

### BRIEF DESCRIPTION OF THE DRAWINGS

The invention will now be described with reference to the appended drawings in which:

FIG. 1 is an enlarged front end cross-sectional view of one type of positioning of optical fibers within a circular preform;

FIG. 2 is a cross-sectional side view along line A-A of FIG. 1, with the middle portion having a reduced diameter due to fusion and stretching of the preform;

FIG. 3 is a cross-sectional side view of a preform such as shown in FIG. 2, but without any fibers inserted therein;

FIG. 4 is a cross-sectional side view of the preform of FIG. 3 into which optical fibers have been inserted;

FIG. 5 is a cross-sectional side view of the preform such as shown in FIG. 2 or FIG. 4 which has been cleaved along line B-B;

FIG. 6 is an enlarged front end cross-sectional view similar to that of FIG. 1, but where the middle fiber has a smaller diameter than the surrounding fibers;

FIG. 7 is a cross-sectional view similar to that of FIG. 6, but where the middle fiber has a diameter larger than the surrounding fibers; and

FIG. 8 is an enlarged front end cross-sectional view of another type of positioning of optical fibers within a circular preform.

### DETAILED DESCRIPTION OF THE INVENTION

The invention will now be described by way of preferred non-limitative embodiments, with reference to the appended drawings in which the same elements are designated by the same reference numbers.

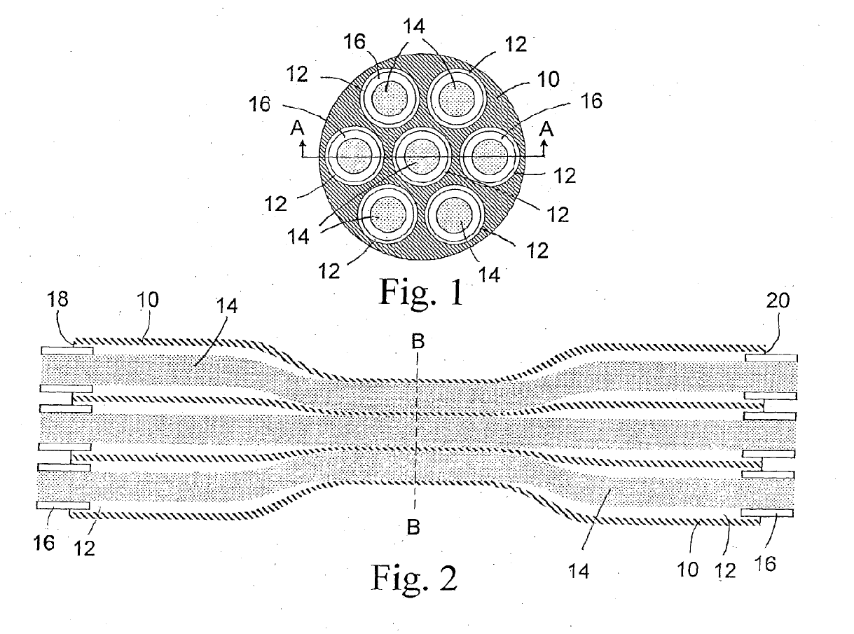

FIG. 1 illustrates one embodiment of the present invention in which a circular glass preform 10 is provided, in which capillary holes 12 are formed in a predetermined disposition. In the present case, all holes are of the same size and are symmetrically disposed with one hole being in the middle, surrounded by six holes around the middle one. These holes are slightly larger than the coated optical fibers 14 that are inserted therein. The fibers 14 have a coating 16 surrounding each fiber 14.

FIG. 2 shows a longitudinal cross-sectional view along line A-A of FIG. 1. Initially, the preform 10 has a diameter shown at either end of FIG. 2. Fibers 14 are inserted into this preform 10 after removal of the coating 16. The insertion is preferably done so that the coated ends of the fiber 14 slightly penetrate into the holes 12 of the preform 10 at each end. This helps to maintain the fibers 14 in a proper position within the preform 10, without sagging within the holes 12. Once this is achieved, the preform 10 is heated in the middle and stretched until the middle tapered portion comes in contact with the fibers 14 within the preform 10 and is slightly fused with the fibers. At this stage, the arrangement looks as shown in FIG. 2 and to solidify the same, drops of glue may be applied at each end 18, 20 in the gaps between holes 12 and coatings 16.

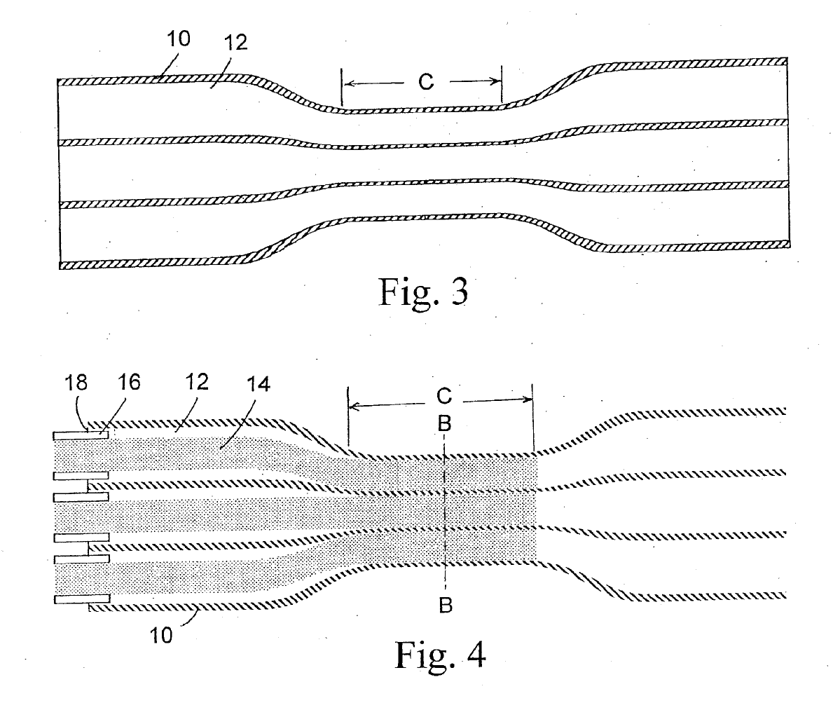

FIGS. 3 and 4 illustrate another method in which a similar positioning may be obtained. Thus, as shown in FIG. 3, the preform 10 with holes 12 provided therein is heated in the middle and stretched until its middle tapered section C is reduced in diameter so that holes 12 in said section essentially correspond to the diameter of uncoated fibers to be inserted thereinto, but are slightly larger to permit insertion of the fibers in such a way that they would contact the periphery of the holes in the tapered section C. This is illustrated in FIG. 4, where uncoated fibers 14 are inserted into the holes 12 and are made to penetrate into the tapered middle section C. At the front end 18, the coating 16 of the fibers 14 slightly penetrates into the holes 12 and when the arrangement is complete, it may again be solidified by drops of adhesive at end 18, in the gaps between the holes 12 and coatings 16. If desired, section C in FIG. 4 can be slightly heated after insertion of the fibers 14 to fuse the same to the periphery of the holes 12 in that tapered section.

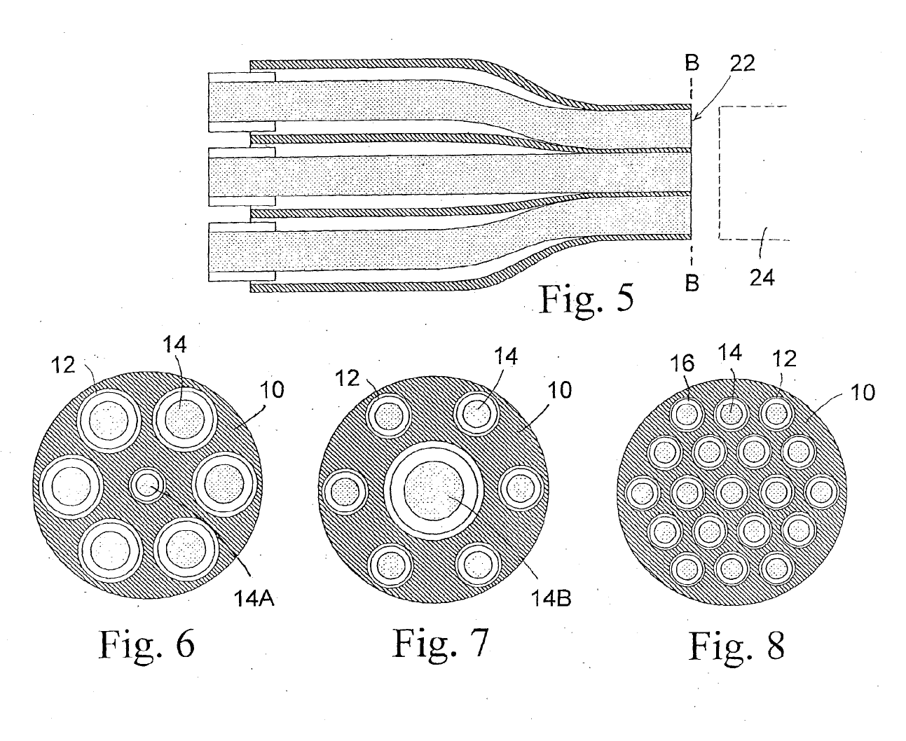

Once the arrangement such as shown in FIG. 2 or FIG. 4 is complete, it is cleaved along line B-B to produce a coupling end face 22 as shown in FIG. 5 which can then be spliced with another fiber 24 shown in dotted lines and which can be any desired fiber suitable for end-to-end coupling, such as, for example an LACDCF.

FIG. 6 shows a similar arrangement of fibers in a preform 10 as shown in FIG. 1, but wherein the central fiber 14A is smaller than the surrounding fibers 14. On the other hand, FIG. 7 shows an arrangement where the central fiber 14B is larger than the surrounding fibers 14. Moreover, FIG. 8 illustrates a different arrangement of a plurality of fibers 14 disposed in a preform 10 according to a predetermined pattern. These figures demonstrate the flexibility of the present invention which allows precise disposition of fibers in making end-to-end couplers of various configurations.

The invention is not limited to the preferred embodiments described above and various modifications obvious to those skilled in the art can be made without departing from the scope of the following claims.

1. In a method of making a fiber optic coupler with precise positioning of optical fibers therein, the steps comprising:
a) providing a glass perform with a plurality of longitudinal capillary holes therein having dimensions slightly larger than those of the optical fibers to be inserted thereinto, said holes being formed in a predetermined configuration within said glass perform;
b) inserting uncoated optical fibers into said holes;
c) heating a section of the glass perform and stretching the same until the uncoated optical fibers in the holes in said section contact the glass perform and fuse therewith, thereby forming a tapered structure with a desired precise positioning of the optical fibers therein; and
d) forming a coupling end in said tapered structure;

2. In a method of making a fiber optic coupler with precise positioning of optical fibers therein, the steps comprising:
a) providing a glass perform with a plurality of longitudinal capillary holes therein having dimensions slightly larger than those of the optical fibers to be inserted thereinto, said holes being formed in a predetermined configuration within said glass perform;
b) heating a section of the glass perform and stretching the same until the holes in said section have reduced dimensions essentially corresponding to those of uncoated optical fibers to be inserted thereinto, said reduced dimensions being large enough to enable insertion of the uncoated optical fibers so that said fibers touch the periphery of said holes with reduced dimensions;
c) inserting uncoated optical fibers into the holes in the glass perform until they penetrate into and substantially fill the section with the holes with reduced dimensions;
d) further heating the section to fuse the inserted fibers with the glass perform in said section, thereby forming a tapered structure with a desired precise positioning of the optical fibers therein; and
e) forming a coupling end in said tapered structure.

3. Method according to claim 1, wherein the glass perform in which the longitudinal capillary holes are formed is cylindrical in shape.

4. Method according to claim 1, wherein the glass perform is formed of a plurality of tubes having capillary holes in them and fused together in the predetermined configuration.

5. Method according to claim 1, wherein the glass perform is made of quartz, fused silica or doped fused silica.

6. Method according to claim 1, wherein the section of the glass perform which is heated and stretched is its middle section.

7. Method according to claim 1, wherein the uncoated optical fibers are inserted into the holes of the perform so that a small portion of coatings remaining on the fibers is also inserted at each end.

8. Method according to claim 2, wherein the uncoated optical fibers are inserted into the holes of the perform so that a small portion of coatings remaining on the fibers is also inserted at the end at which the fibers are inserted.

9. Method according to claim 1, wherein after formation of the tapered structure, adhesive is applied at least at one end of the perform so as to solidify said structure.

10. Method according to claim 1, wherein the coupling end in said tapered structure is formed by placing the structure under tension and cleaving said structure to form the coupling end.

11. Method according to claim 1, wherein the coupling end in said tapered structure is formed by placing the structure under tension and polishing said structure to form the coupling end.

12. Method according to claim 1, wherein the coupling end is spliced to an end of another fiber to form the coupler.
